(19) United States
(12) Patent Application Publication
(10) Pub. No.: US 2017/0024942 A1
(43) Pub. Date: Jan. 26, 2017

(54) SYSTEM AND METHOD FOR DETERMINING A PROTOCOL OF A VEHICLE

(71) Applicant: Drew Technologies, Inc., Ann Arbor, MI (US)

(72) Inventors: Michael Drew, Dexter, MI (US); Brian Herron, Dexter, MI (US); Ghassan Nassar, Canton, MI (US)

(21) Appl. No.: 15/212,914

(22) Filed: Jul. 18, 2016

Related U.S. Application Data
(60) Provisional application No. 62/194,532, filed on Jul. 20, 2015.

(51) Int. Cl. G07C 5/08; G07C 5/00

(52) U.S. Cl. CPC G07C 5/0808; G07C 5/085; G07C 5/008; G07C 2205/02

(57) ABSTRACT

A system and method for querying an on board diagnostic system of a vehicle includes a processor, a port in communication with the processor and an input device in communication with the processor. The port is configured to communicate with the on board diagnostic system of a vehicle. The input device is configured to receive a vehicle identification number of the vehicle. The processor is configured to determine protocol utilized by the vehicle based on the vehicle identification number of the vehicle and the data in a database which contains data to identify the protocol the vehicle utilizes. After a determination of the protocol utilized by the vehicle is performed, the processor is further configured to communicate with the vehicle using the protocol previously identified.

### CROSS REFERENCE TO RELATED APPLICATIONS

This application claims priority to U.S. Provisional Patent Application 62/194,532 filed on Jul. 20, 2015, which is incorporated by reference in its entirety.

### BACKGROUND

1. Field of the Invention

The present invention relates to systems and methods for communicating with the onboard diagnostic system of a vehicle.

2. Description of Related Art

Currently, approximately 30 states have requirements that require vehicles to undergo some form of periodic inspection. Most commonly, the periodic inspection of the vehicle involves emissions testing of the vehicle. As it is known, emissions testing of a vehicle generally involves connecting the vehicle to an external device, such as a computer loaded with the appropriate software or a dedicated device having the appropriate firmware. The external device that is connected to the vehicle will perform a series of inquiries of one or more electronic systems that are located within the vehicle. To accomplish this, the device must communicate with the vehicle systems and subsystems using an appropriate protocol.

The periodic inspection of the vehicles is in some cases performed by the state and is in other cases performed by a third party, such as a repair shop. In either case, the party performing the inspection may have dozens or even hundreds of vehicles that they need to perform the appropriate inspection. As such, it is preferable that the inspections be performed as quickly as possible, so that more vehicles can be quickly inspected, ultimately saving the operator of the vehicle time by not having to wait lengthy periods of time for their vehicle to be inspected.

### SUMMARY

A system and method for querying an on-board diagnostic system of a vehicle includes a processor, a port in communication with the processor and an input device in communication with the processor. The port is configured to communicate with the on-board diagnostic system of a vehicle. The input device is configured to receive a vehicle identification number of the vehicle. The processor is configured to determine protocol utilized by the vehicle based on the vehicle identification number of the vehicle and data in a database which contains data to identify the protocol the vehicle utilizes. After a determination of the protocol utilized by the vehicle is performed, the processor is further configured to communicate with the vehicle using the protocol previously identified.

Further objects, features, and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a system for querying an onboard diagnostic system of the vehicle;

FIG. 2 illustrates another embodiment of the system for querying an onboard diagnostic system of a vehicle;

FIG. 3 illustrates another embodiment of the system for querying an onboard diagnostic system of a vehicle, wherein a database is located at a remote location; and

FIG. 4 illustrates the method for querying an onboard diagnostic system of a vehicle.

### DETAILED DESCRIPTION

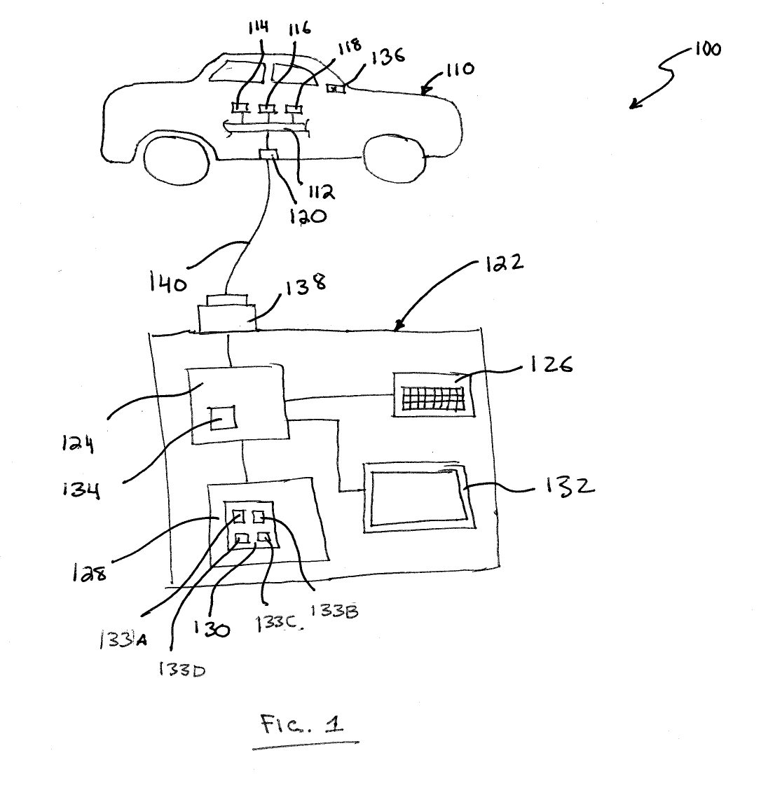

Referring to FIG. 1, a system 100 for querying an onboard diagnostic system of a vehicle 110 is shown. It should be understood that the vehicle 110 can be any one of a number of different types of vehicles. For example, the vehicle 110 could be a car, truck, sport utility vehicle, cross over utility vehicle, van, minivan, or the like. Additionally, the vehicle 110 could also be a commercial grade vehicle, such as a commercial truck or heavy duty truck or could even include farm-related equipment, such as tractors. The vehicle 110 could also be a boat or airplane. In any case, the vehicle 110 should be interpreted as being any vehicle that is capable of transporting objects or persons from one point to another.

The vehicle 110 generally includes a data bus 112. The data bus 112 is capable of allowing multiple vehicle subsystems 114, 116, and 118 to communicate with each other. In addition to allowing the vehicle subsystems 114, 116, and 118 to communicate with each other, the bus 112 also allows these vehicle subsystems 114, 116, and 118, to communicate with a port 120. The port 120 allows an external device to communicate with any device connected to the bus 112.

The vehicle subsystems previously mentioned may include any one of a number of different vehicle subsystems. For example, the vehicle subsystems 114, 116, and/or 118, may perform any one of a number of different functions. For example, these functions could include active safety functions, such as airbags, seatbelts, and/or vehicle braking systems. These systems could also control other functions such as powertrain control, engine control, emissions-related functions, and/or diagnostics related functions. It should be understood that the previously provided list should not be limited and can include any one of a number of different functions performed by the electronics and related mechanical systems of the vehicle 110.

The bus 112 may be any one of a number of different buses. For example, the bus 112 may be a controller area network type bus commonly found in automobiles. The port 120 may be any one of a number of different types of ports. For example, the port may be a serial port, parallel port, or an industry standard type port, such as a universal serial bus port. Additionally, it should be understood the port 120 may be an On-Board Diagnostic (“OBD”) type port. More specifically, the port may be an OBD-II diagnostic connector defined by the Society of Automotive Engineers J1962 specification. Additionally, while the port 120 may be a physical port configured to be connected to a cable, the port 120 may also function as a wireless network access device. Essentially, the port 120 instead of connecting into a cable would have a wireless transceiver allowing the bus 112 to communicate with external devices wirelessly.

A device 122 for querying the onboard diagnostic system of the vehicle 110 includes a processor 124, an input device 126, and a memory 128 having a database 130. Additionally, the device 122 may also include an output device 132. Generally, the input device 126, the memory 128, and the output device 132 are all in communication with the processor 124. The processor 124 may be a single processor or may be multiple processors working in concert. The processor 124 may be configured to perform any of a number of different methods disclosed in the specification by executing instructions 134. The instructions 134 may be stored within the processor 124 itself or on a separate device, such as memory 128.

It should be understood that the memory 128 may be any one of a number of different devices capable of storing digital information. For example, the memory 128 may be a solid state device, a magnetic storage device and/or an optical storage device. Additionally, it should be understood that the memory 128 may be a separate and distinct device as shown, or may be incorporated within another device, such as the processor 124.

The memory 128 may include a database 130 having a plurality of different entries, such as tables 133A, 133B, 133C, and 133D. The data 133A-133D may include data useful for identifying a communication protocol utilized by the vehicle 110.

Input device 126 may be any one of a number of different input devices capable of receiving information related to the vehicle identification number of the vehicle 110. Generally, the vehicle 110 has one or more areas listing the vehicle identification number. The vehicle identification vehicle of the vehicle 110 is unique for each and every vehicle. The vehicle identification number can be utilized to determine where the vehicle was made, the make, model and/or year of the vehicle, or other identifying information, such as differences in powertrain, etc. Generally, the vehicle identification number may be located in an area 136 near a windshield of a vehicle 110. Additionally, the area 136 where the vehicle identification number is located may also be the doorpost of the vehicle or could be other areas located on the vehicle 110. Here, the input device 126 is a keypad capable of receiving an input from an operator regarding the vehicle identification number of the vehicle 110. The keypad may be a physical keypad or may be a touchscreen.

The output device 132 may be any one of a number of different output devices capable of displaying visual information to an operator of the device 122. For example, the output device 132 may be a screen capable of displaying information or could be simpler, such as a light indicating that the vehicle 110 has passed a test. It should be understood that the output device 132 may be capable of displaying information from the vehicle subsystems 114, 116, and/or 118 of the vehicle 110.

The device 122 is capable of communicating with the vehicle 110 via a port 138. The port 138 is in communication with the processor 124. A cable 140 allows the port 138 to communicate with the port 120 of the vehicle 110. The port 138 may be similar to the port 120 of the vehicle 110. For example, the port 138 may be any one of a number of different parallel or serial communication ports. In addition, it should be understood that the port 138 may be a wireless network access device, allowing the device 122 to communicate with the vehicle 110 wirelessly.

The instructions 134 may configure the processor 124 to perform any one of a number of different methods. Here, the processor 124 may be configured by the instructions 134 to receive a vehicle identification number from the input device 126. As stated before, this vehicle identification number may be the vehicle identification number of the vehicle 110.

Thereafter, the processor 124 may be configured to determine the protocol utilized by the vehicle 110 based on the vehicle identification number of the vehicle and the data 134A-134D located in the data base 130. For example, the database 130 may have a cross reference table cross referencing the vehicle identification number of the vehicle 110 to the type of protocol the vehicle 110 is utilizing. Additionally or alternatively, the processor 124 may be able to determine the protocol the vehicle 110 is utilizing by determining using data in the database the make, model, and/or year of the vehicle 110. For example, vehicles made after a certain year may be utilizing one form of protocol, while a vehicle made from an earlier year may be utilizing a different protocol. The same is true regarding make and model. Some makes and/or some models utilize one type of protocol, while other makes and/or models utilize a different protocol. In any case, the processor 124 will be able to determine what type of protocol the vehicle 110 is utilizing based on the vehicle identification number and data located within the database 130.

After that, the processor 124 via the port 138 may be configured to communicate with the vehicle 110 using the previously identified protocol. By identifying the protocol by using the database 130, the processor 124 can more quickly begin communicating with the vehicle 110 in performing any one of a number of different testing procedures, such as emissions testing. This will save significant time in the testing process, allowing operators to perform more diagnostics of more vehicles over a shorter period.

Additionally, the processor 124, based on the vehicle identification number and/or data in the database 130 may be configured to only request information from the vehicle 110 of data items that the vehicle subsystems 114, 116, and/or 118 posses. By so doing, the processor 124 can more efficiently operate, as it will be requesting data items that the processor 124 knows only the vehicle 110 has. The processor 124 will not be bogged down requesting data items that the vehicle 110 is not in possession of. Again, this has the distinct advantage of allowing testing of the vehicle 110 to be performed more quickly.

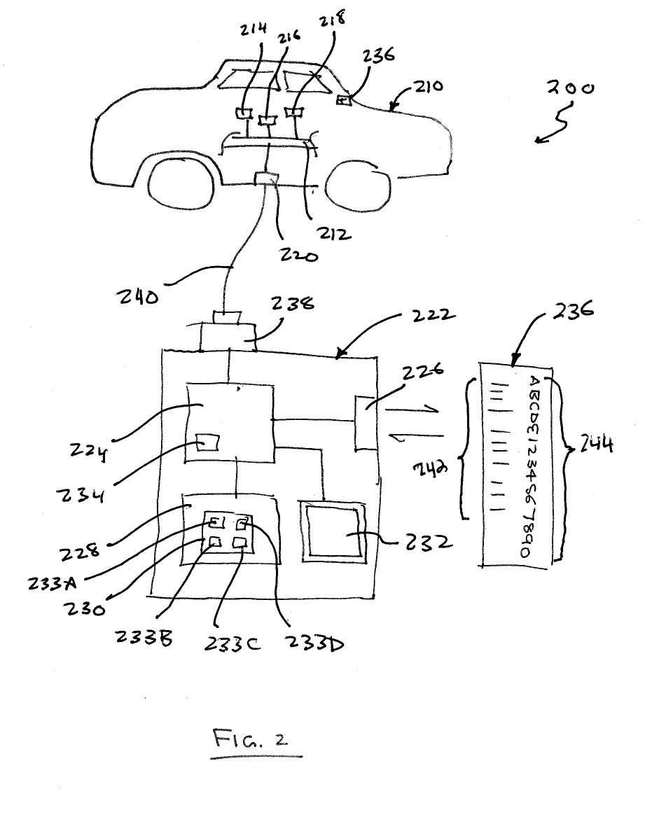

Referring to FIG. 2, another embodiment of the device 222 for querying an onboard diagnostic system of the vehicle 210 is shown. Here, like reference numerals have been utilized to indicate like components. If no further description is given, the previously given description of the components is equally applicable to the embodiment shown in FIG. 2. The device 222 differs from that of FIG. 1 in that the input device 226 may be an optical scanning device. The input device 226 may be a bar code reader or may be a camera system capable of capturing visual information. Here, the input device 226 is capable of reading the area 236 of the vehicle 210 containing the vehicle identification number. For example, the input device 226 may be able to read a bar code 242 containing the vehicle identification number.

Additionally and/or alternatively, the input device 226 may be a camera system capable of visually capturing the vehicle identification number 244 located in the area 236 of the vehicle 210. In this manner, the vehicle identification number can be provided to the processor 224 and any one of a number of different methods previously described can be performed using this vehicle identification number information.

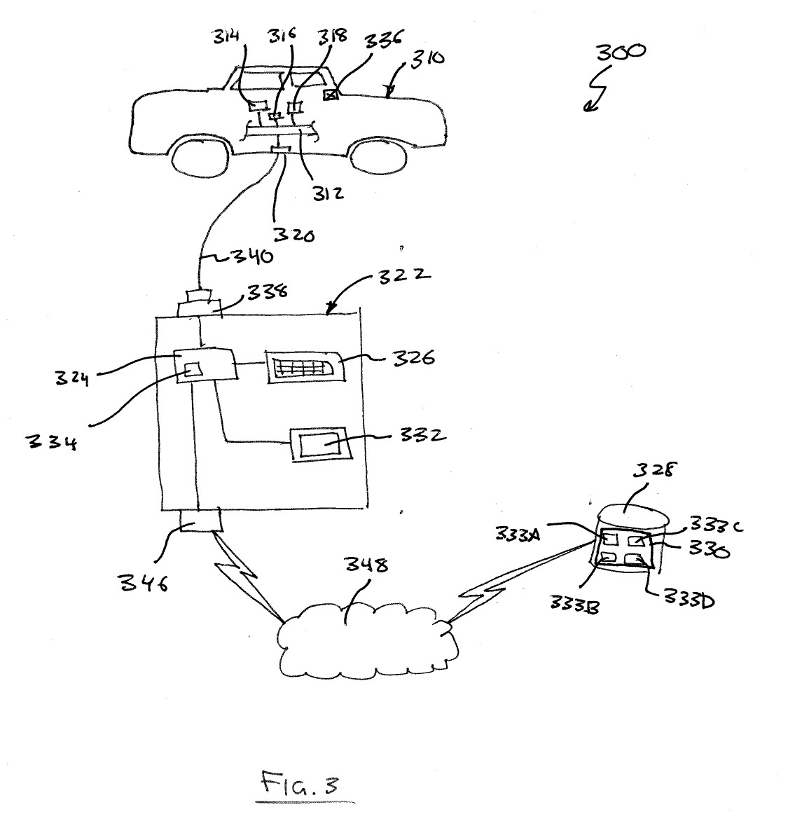

Referring to FIG. 3, another embodiment of the device 322 for querying an onboard diagnostic system of a vehicle 310 is shown. Like before, like reference numerals have been utilized to refer to like components. If no additional description is given, then it can be assumed that the previous description isn't fully applicable. Additionally, it should be understood that while the input device 326 of FIG. 3 is a keypad or touchscreen, it should be understood that the input device 326 may also be the optical input device 226 of FIG. 2.

Here, the device 322 includes an additional port 346 that is in communication with the processor 324. Additionally, the memory 328 contained the database 330 is located remote from the device 322. The port 346 communicates with a network 348 that allows for communication with the memory 330. The network 348 may be a direct connection, such as a cable, or may be a local or distributed network, such as the Internet. The port 346 may be any one of a number of different ports allowing communication with an external device. For example, the port may be a universal serial bus port, Ethernet port, and the like. Additionally, the port 346 may be a wireless network access device allowing the device 322 to communicate with external devices wirelessly.

As such, the memory 328 may be located on a remote data storage site. By so doing, the data storage site can act as a central repository for information relating to the vehicle identification number of a vehicle 310 and related protocol information. This central site can be used to allow for a single source of information, further allowing that single source of information to be updated from time to time. By so doing, a comprehensive database of all vehicle identification numbers and related vehicle information can be updated cost effectively and routinely.

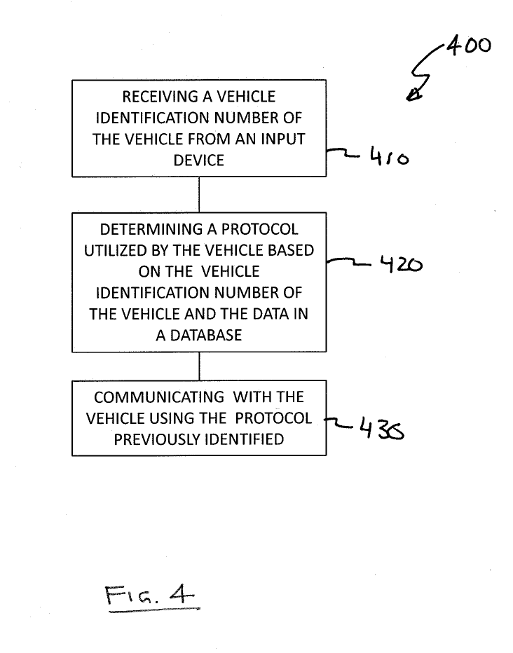

Referring to FIG. 4, a method for querying an onboard diagnostic system of a vehicle is shown. This method may be incorporated in any one of the devices disclosed in the specification. The method 400 may also be utilized by devices not specifically disclosed in the specification. In step 410, the method 400 begins by receiving a vehicle identification number of the vehicle from an input device. As stated previously, the input device could be a touch screen, keypad, or optical reader. Of course, any one of a number of different input devices could be utilized so as long as they are capable of providing information.

In step 410, a determination of a protocol utilized by the vehicle based on the vehicle identification number and the data in the database is performed. As stated previously, the database includes data capable of identifying the protocol a vehicle utilizes. The database may have a cross reference table cross-referencing the vehicle identification number to a known protocol. Additionally, the database may provide the year, make, model, and/or other information of the vehicle. From there, this information could be utilized to determine the protocol utilized by the vehicle.

After a determination is made regarding the protocol utilized by the vehicle, in step 430, the step of communicating with the vehicle using the protocol previously identified is performed. As stated previously, by determining the protocol before communicating with the vehicle, time can be saved in performing any one of a number of various different inspections of the vehicle. By so doing, more vehicles can be inspected and processed.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from the spirit of this invention, as defined in the following claims.

1. A device for querying an on board diagnostic system of a vehicle, the device comprising:
a processor;
a port in communication with the processor, the port being configured to communicate with the on board diagnostic system of a vehicle;
an input device in communication with the processor, the input device configured to receive a vehicle identification number of the vehicle;
a database in communication with the processor, the database comprising data to identify the protocol the vehicle utilizes;
wherein the processor is configured to determine protocol utilized by the vehicle based on the vehicle identification number of the vehicle and the data in the database; and
wherein, after a determination of the protocol utilized by the vehicle is performed, the processor is further configured to communicate with the vehicle using the protocol previously identified.

2. The device of claim 1, wherein the input device is a keypad or touchscreen, wherein the keypad or touchscreen is configured to receive an input from an operator.

3. The device of claim 1, wherein the input device is scanner configured to read the vehicle identification number from at least one location of the vehicle.

4. The device of claim 1, wherein the processor is configured to determine a model year of the vehicle based on the vehicle identification number of the vehicle and the data in the database.

5. The device of claim 4, wherein the processor is configured to determine the protocol utilized by the vehicle based on the model year of the vehicle.

6. The device of claim 1, wherein the processor is configured to determine a make and model of the vehicle based on the vehicle identification number of the vehicle and the data in the database.

7. The device of claim 6, wherein the processor is configured to determine the protocol utilized by the vehicle based on the make and model of the vehicle.

8. The device of claim 1, wherein the processor is configured to determine data items that the on board diagnostic system of the vehicle contains and only request information from the vehicle of the determined data items.

9. A method for querying an on board diagnostic system of a vehicle, the method comprising the steps of:
receiving a vehicle identification number of the vehicle from an input device;
determining a protocol utilized by the vehicle based on the vehicle identification number of the vehicle and the data in a database, the database comprising data to identify the protocol the vehicle utilizes;
after the determination of the protocol utilized by the vehicle is performed, communicating with the vehicle using the protocol previously identified.

10. The method of claim 9, wherein the input device is a keypad or touchscreen, wherein the keypad or touchscreen is configured to receive an input from an operator.

11. The method of claim 9, wherein the input device is scanner configured to read the vehicle identification number from at least one location of the vehicle.

12. The method of claim 9, further comprising the step of determining a model year of the vehicle based on the vehicle identification number of the vehicle and the data in the database.

13. The method of claim 12, further comprising the step of determining the protocol utilized by the vehicle based on the model year of the vehicle.

14. The method of claim 9, further comprising the step of determining a make and model of the vehicle based on the vehicle identification number of the vehicle and the data in the database.

15. The method of claim 14, further comprising the step of determining the protocol utilized by the vehicle based on the make and model of the vehicle.

16. The method of claim 9, further comprising the steps of determining data items that the on board diagnostic system of the vehicle contains and only requesting information from the vehicle of the determined data items.
